(19) United States
(12) Patent Application Publication
(10) Pub. No.: US 2021/0068389 A1
(43) Pub. Date: Mar. 11, 2021

(54) Organ Preservation Perfusion Pump with Spectral Imaging

(71) Applicant: Bridge to Life Ltd., Northbrook, IL (US)

(72) Inventor: Michael R. Kappler, London (GB)

(21) Appl. No.: 17/004,499

(22) Filed: Aug. 27, 2020

Related U.S. Application Data
(60) Provisional application No. 62/898,929, filed on Sep. 11, 2019.

(51) Int. Cl. A01N 1/02

(52) U.S. Cl. CPC A01N 1/0247

(57) ABSTRACT

A system includes a perfusion pump, a spectrometer, and a processor. The perfusion pump is configured to selectively pump fluid into and from an organ along a fluid path. The spectrometer includes at least one optical source positioned to emit light through the fluid path and at least one detector positioned to detect light emitted by the at least one optical source. The processor is coupled (i.e., in electrical communication) with the at least one detector to translate an intensity of light detected by the at least one detector into at least one organ viability metric. Related apparatus, systems, techniques and articles are also described.

### RELATED APPLICATION

The current application claims priority to U.S. Pat. App. Ser. No. 62/898,929 filed Sep. 11, 2019, the contents of which are hereby fully incorporated by reference.

### TECHNICAL FIELD

The subject matter described herein relates to a perfusion pump used for the preservation of organs as part of a transplant process that includes spectral imaging to characterize the viability of such organs during the transplant process.

### BACKGROUND

Organ transplantation is a medical procedure in which an organ is removed from one body and placed in the body of a recipient, to replace a damaged or missing organ. Such organs are typically retrieved from a donor after brain death (DBD) or circulatory death (DCD). Often, such organs need to be preserved and/or transported to a recipient as part of a transplant process. However, there are many points at which an organ can and will be damaged including during the process of retrieval from the donor, during subsequent ischemia (i.e., a condition in which there is an inadequate supply of blood to the organ), and when being implanted. In order to help maintain the viability of extracted organs, perfusion pumps can be used to pump solution through the organ in order to deliver oxygen and to prepare the organ for implant into the recipient.

### SUMMARY

In a first aspect, an apparatus/system includes a perfusion pump, a spectrometer, and a processor. The perfusion pump is configured to selectively pump fluid into and from an organ along a fluid path. The spectrometer includes at least one optical source positioned to emit light through the fluid path and at least one detector positioned to detect light emitted by the at least one optical source. The processor is coupled (i.e., in electrical communication) with the at least one detector to translate an intensity of light detected by the at least one detector into at least one organ viability metric.

In some variations, a tubing set can be provided which is configured to couple to the perfusion pump and to the organ to form the fluid path. The tubing set can include a flow cell portion such that the at least one optical source is positioned on a first side of the flow cell portion and the at least one detector is positioned on a second, opposing side of the flow cell to characterize fluid perpendicularly passing through the flow path. The flow cell portion can include at least one window through which the light is emitted by the at least one optical source. The window can be made from various materials including, without limitation, clear polycarbonate.

The perfusion pump can encapsulate the housing. In some variations, the housing can also encapsulate the spectrometer. In other variations, the spectrometer can be positioned external to the housing either coupled to an external face of the housing and or elsewhere.

The at least one light source can take various forms including at least one light emitting diode (LED). The at least one LED can be an LED emitting light at a wavelength (e.g., 485 nm, etc.) to excite flavin mononucleotide (FMN) molecules to fluoresce. In addition or in the alternative, the at least one LED comprises an LED emitting light at a wavelength (e.g., 360 nm, etc.) to excite nicotinamide adenine dinucleotide+hydrogen (NADH) molecules to fluoresce.

In an interrelated aspect, a perfusion pump pumps fluid along a fluid path into and from an organ. Thereafter, a spectrometer having at least one optical source and at least one detector, detects an intensity of light emitted across the fluid path. Based on this detected intensity, at least one viability metric characterizing viability of the organ can be provided (e.g., displayed in an electronic visual display, stored in physical persistence, loaded into memory, transmitted to a remote computing system, etc.).

The subject matter described herein provides many technical advantages. For example, the current subject matter provides a real-time indication of the health of the organ before the decision is made to implant or discard it. Such an indication provides a reliable measure of the amount of damage the organ has suffered, and therefore the likelihood of it properly functioning upon implant into the recipient.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a sample tubing set for use with a perfusion pump; and

FIG. 2 is a diagram illustrating a perfusion pump showing a variation with an external spectrometer.

### DETAILED DESCRIPTION

The current subject matter is directed to a perfusion pump with spectral imaging that can characterize the viability of an organ during a transplant process. In some variations, the spectral imaging can be integrated within a perfusion pump housing. In other variations, the spectral imaging can be an external spectroscopy device that can interface with a tubing set utilized by the perfusion pump.

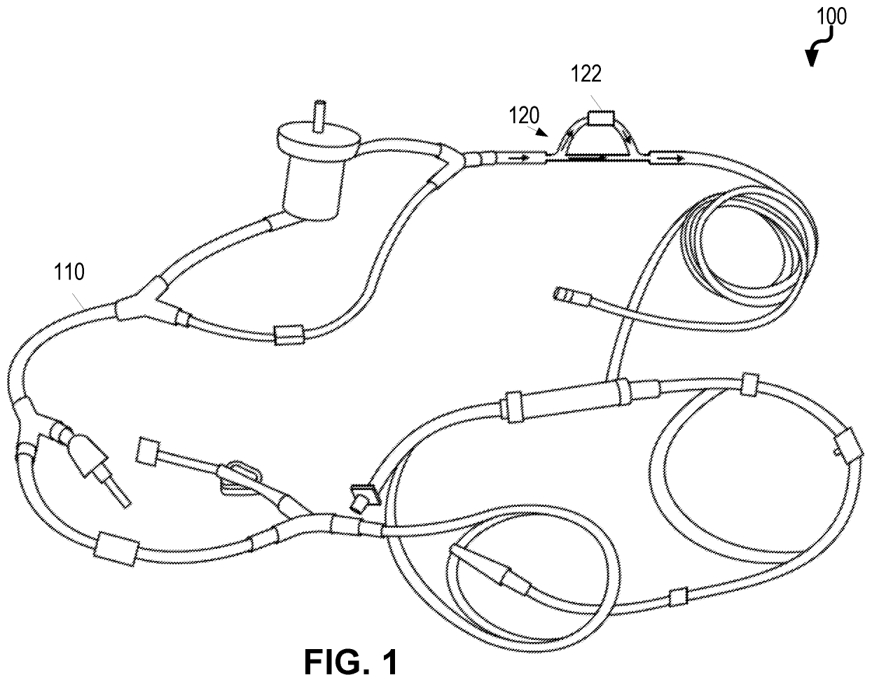

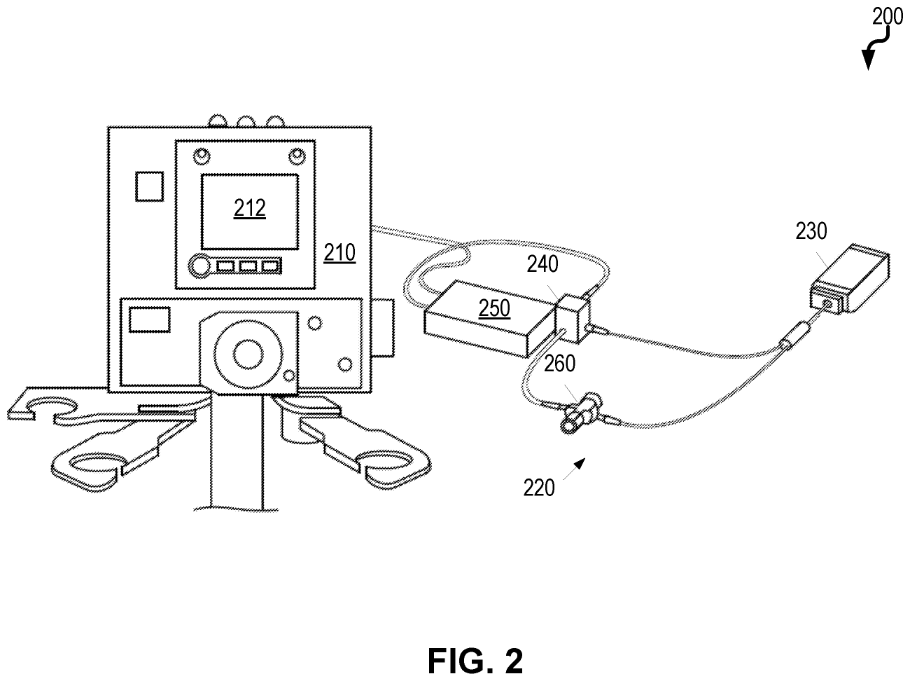

FIG. 1 is a diagram 100 of a tubing set 110 for use with a perfusion pump (such as perfusion pump 210 in diagram 200 of FIG. 2). The tubing set 110 can be coupled to the perfusion pump 210 and, additionally, to an organ being transplanted (not shown). The perfusion pump 210, in operation, acts to pump fluid from an external fluid source into the organ, and additionally, acts to repeatedly recirculate the fluid through the organ and the perfusion machine. The tubing set 110 can include a flow cell portion 120. The flow cell portion 120 can, in some variations, include an optical window 122 along a fluid bypass 124. This optical window 122 can have shape and size so as to permit, on one side, a light to be emitted therethrough (either directly or via an optically tapped light source). The optical window 122 can also have a shape and size as to permit, on a different size, the light emitted through the optical window 122 to be detected (either directly by a detector or via an optically tapped detector).

FIG. 2 is a diagram 200 of a perfusion pump 210 having an associated spectrometer 220. While in this variation, the spectrometer 220 is shown as being external to a housing of the perfusion pump 210, it will be appreciated that the spectrometer 220 can be integrated within the housing of the perfusion pump 210 or otherwise mechanically secured to an external surface of the perfusion pump 210 (i.e., the spectrometer 220 can be an add-on to an existing perfusion pump or otherwise modular, etc.). The spectrometer 220 comprises at least one light source 230. The light source 230 can take various forms including, for example, including an LED, a laser, or other light source for emitting light across a wavelength or a wavelength range of interest. The spectrometer 220 can also include at least one detector 240 which can detect light being emitted across a wavelength or a wavelength range of interest. The detector 240 can take various forms so that an intensity of emitted light can be quantified (and in some cases at specific wavelengths and/or specific wavelength ranges). A control unit 250 including at least one data processor can take values measured by the detector 240 and transform such values into an organ viability characteristic (which can be displayed numerically or in a graphical user interface on an integrated display 212). As used herein, an organ viability characteristic can be indicated. The spectrometer 220 can also include a surround 260 which includes an optical cell configured to fit with and surround the optical window 122 of the flow cell portion. The surround 260, in some variations, can be integrated within the housing of the perfusion pump 210.

In some variations, the spectrometer 220 can be used to measure a fluorescing molecule. In some cases, such molecules can be naturally produced within mitochondria of the organ being transplanted. The presence or absence of such molecules can be an important indicator of mitochondrial health. For example, FMN and NADH naturally fluoresce. Other indicators which can be detected spectrally, whether by way of fluorescence or otherwise, can also be detected by the spectrometer 220.

In one example, the spectrometer 220 is configured to spectrally detect a flavin mononucleotide (FMN) which is released from the mitochondria if it is damaged such that the electrons cannot move from Complex 1 to Complex 2 and then onward through the other complexes during oxidative phosphorylation. As such, FMN can be characterized as a measure of damage. FMN is also known as Vitamin B2. The more FMN the more mitochondrial injury and reactive oxygen species (ROS) production. ROS may result in inflammation, fibrosis, and reperfusion damage.

In another example, the spectrometer 220 is configured to additionally or alternatively spectrally detect nicotinamide adenine dinucleotide (NAD)+hydrogen (H) (NADH) which is a co-enzyme involved in oxidative phosphorylation. The release of NADH reflects injury and reduced functioning of the mitochondria which is primarily to produce ATP which is the energy source used by the cells.

In some variations, the spectrometer 220 can detect both FMN and NADH. A low level of NADH and a low level of FMN can give the surgeon an indication that the organ should work well. High FMN and high NADH would suggest that the organ is too damaged to expect it to work immediately, or at all.

Either one measurement could be helpful in itself. High FMN or NADH indicates mitochondrial damage. Measuring both will give a better indication of organ viability, but either one will be of some value.

Both indicators can be measured by the spectrometer 220 during the first 30 minutes of hypothermic oxygenated machine perfusion and throughout the period of perfusion. The oxygen is necessary for mitochondrial function. Typically, machine perfusion will last for 1-5 hours and the FMN and NADH production throughout will be of interest, but it is the first 30 minutes which give the important first indication of organ health. That first 30 minutes may predict the functioning of the organ over the following 2 critical days.

In some variations, the at least one light source 230 comprises two LEDs which shine at pre-determined wavelengths to excite the FMN and NADH molecules (485 nm and 360 nm respectively) to induce fluorescence. The light sources 230 shine light through the perfusate in the machine perfusion fluid path (sometimes referred to as a circuit). To ensure the light emitted by the light sources 230 is not impacted by the tubing, the flow cell portion 120 can act as an insert in the tubing and can be made of an optically suitable material such as clear polycarbonate.

The spectrometer 220 can include a surround 260 which surrounds the flow cell portion 110 (when coupled thereto) so as to have the light emitted from the at least one light source 220 pass through the fluid path for detection by the at least one detector 230 (either directly or via optically tapping). The at least one detector 230 detects a level of fluorescence and the control unit 250 converts it into data forming the viability characteristic or used to form the viability characteristic. This information can be stored or transmitted and used to provide to create a real-time (i.e., continuously updated) graphical user interface display 212 attached to the housing of the perfusion machine and/or made available via a mobile phone application (or on a website, etc.).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An apparatus comprising:
a perfusion pump configured to selectively pump fluid into and from an organ along a fluid path;
a spectrometer comprising:
at least one optical source positioned to emit light through the fluid path; and
at least one detector positioned to detect light emitted by the at least one optical source;
a processor coupled to the at least one detector to translate an intensity of light detected by the at least one detector into at least one organ viability metric.

2. The apparatus of claim 1 further comprising:
a tubing set configured to couple to the perfusion pump and to the organ to form the fluid path.

3. The apparatus of claim 2, wherein the tubing sets comprises a flow cell portion;
wherein the at least one optical source is positioned on a first side of the flow cell portion and the at least one detector is positioned on a second, opposing side of the flow cell to characterize fluid perpendicularly passing through the flow path.

4. The apparatus of claim 3, wherein the flow cell portion comprises at least one window through which the light is emitted by the at least one optical source.

5. The apparatus of claim 4, wherein the window is made from clear polycarbonate.

6. The apparatus of claim 2 further comprising:
a housing encapsulating the perfusion pump.

7. The apparatus of claim 3, wherein the housing further encapsulates the spectrometer.

8. The apparatus of claim 3, wherein the spectrometer is positioned external to the housing.

9. The apparatus of claim 8, wherein spectrometer is coupled to an external face of the housing.

10. The apparatus of claim 1, wherein the at least one light source comprises:
at least one light emitting diode (LED).

11. The apparatus of claim 10, wherein the at least one LED comprises an LED emitting light at a wavelength to excite flavin mononucleotide (FMN) molecules to fluoresce.

12. The apparatus of claim 11, wherein the wavelength is 485 nm.

13. The apparatus of claim 9, wherein the at least one LED comprises an LED emitting light at a wavelength to excite nicotinamide adenine dinucleotide+hydrogen (NADH) molecules to fluoresce.

14. The apparatus of claim 13, wherein the wavelength is 360 nm.

15. The apparatus of claim 12, wherein the at least one LED comprises an LED emitting light at 360 nm to excite nicotinamide adenine dinucleotide+hydrogen (NADH) molecules to fluoresce.

16. A method comprising:
pumping, by a perfusion pump along a fluid path, fluid into and from an organ;
detecting, by a spectrometer having at least one optical source and at least one detector, an intensity of light emitted across the fluid path;
providing, based on the detection, at least one viability metric characterizing viability of the organ.

17. The method of claim 16, wherein the fluid path is defined by a tubing set configured to couple to the perfusion pump and to the organ.

18. The method of claim 16, wherein the tubing sets comprises a flow cell portion;
wherein the at least one optical source is positioned on a first side of the flow cell portion and the at least one detector is positioned on a second, opposing side of the flow cell to characterize fluid passing through the flow path.

19. The method of claim 16, wherein the flow cell portion comprises at least window through with the light is emitted by the at least one optical source.

20. The method of claim 16, wherein a housing encapsulates the perfusion pump.

21. The method of claim 20, wherein the housing further encapsulates the spectrometer.

22. The method of claim 20, wherein the spectrometer is positioned external to the housing.

23. The method of claim 22, wherein spectrometer is coupled to an external face of the housing.

24. The method of claim 16, wherein the at least one light source comprises:
at least one light emitting diode (LED).

25. The method of claim 24, wherein the at least one LED comprises an LED emitting light at a wavelength to excite flavin mononucleotide (FMN) molecules to fluoresce.

26. The method of claim 25, wherein the wavelength is 485 nm.

27. The method of claim 26, wherein the at least one LED comprises an LED emitting light at a wavelength to excite nicotinamide adenine dinucleotide+hydrogen (NADH) molecules to fluoresce.

28. The method of claim 27, wherein the wavelength is 360 nm.

29. The method of claim 24, wherein the at least one LED comprises an LED emitting light at a wavelength to excite nicotinamide adenine dinucleotide+hydrogen (NADH) molecules to fluoresce.

30. The method of claim 29, wherein the wavelength is 360 nm.

31. An apparatus comprising:
means for pumping fluid into and from an organ along a fluid path;
spectroscopic means for detecting an intensity of light emitted across the fluid path;
means providing, based on the detection, at least one viability metric characterizing viability of the organ.
